(19) United States
(12) Patent Application Publication
(10) Pub. No.: US 2024/0149435 A1
(43) Pub. Date: May 9, 2024

(54) ROBOT

(71) Applicant: SEIKO EPSON CORPORATION, Tokyo (JP)

(72) Inventor: Daisuke NAKANISHI, AZUMINO-SHI (JP)

(21) Appl. No.: 18/387,064

(22) Filed: Nov. 6, 2023

(30) Foreign Application Priority Data
Nov. 8, 2022 (JP) 2022-178668

(51) Int. Cl. B25J 9/04; B25J 9/10

(52) U.S. Cl. CPC B25J 9/042; B25J 9/10

(57) ABSTRACT

A robot includes a base section, a robot arm connected to the base section along a first axis and configured to pivot about the first axis, a heat generating member, a first opening section arranged at a tip end side of the robot arm, a second opening section arranged further toward a first axis side than is the first opening section of the robot arm or arranged in the base section, and a flow path communicating between the first opening section and the second opening section and through which outside air flows from the second opening section toward the first opening section by operation of the robot arm, wherein the heat generating member is arranged at a position along the flow path.

### CROSS-REFERENCE TO RELATED APPLICATIONS

The present application is based on, and claims priority from JP Application Serial Number 2022-178668, filed Nov. 8, 2022, the disclosure of which is hereby incorporated by reference herein in its entirety.

### BACKGROUND

### 1. Technical Field

The present disclosure relates to a robot.

### 2. Related Art

A robot arm and a base section that supports the robot arm contains a device that generates heat. Examples of such a device include a motor and a control substrate. A cooling unit is desired to avoid degradation of performance of the device.

For example, JP-T-2022-521440 discloses a base section that supports a robot arm. A robot system is disclosed that includes, as the base section, a bracket forming a first thermal conduction path for dissipating heat from a heat generating part and a thermal pad forming a second thermal conduction path for dissipating heat from the heat generating part. Heat dissipation can be advantageously improved by the bracket and the thermal pad, because a plurality of thermal conduction paths are formed.

The base section includes a rear section with a first heat sink and a front section with a second heat sink. The first thermal conduction path described above is formed from the heat generating part to the first heat sink via the bracket. The second thermal conduction path described above is formed from the heat generating part to the second heat sink via the bracket and the thermal pad.

However, in the base section described in JP-T-2022-521440, heat dissipation by the heat sinks is required. Although it is necessary to increase the size of the heat sinks in order to improve heat dissipation performance, in this case, there are restrictions on installation locations of the heat sinks. The robot arm is a movable section and needs to be reduced in weight. Therefore, it is difficult to install a heat sink on a robot arm. On the other hand, an active part such as a fan that promotes heat dissipation causes an increase in energy consumption of a robot.

Therefore, it is a problem to dissipate heat from a heat generating device without restricting installation locations of members necessary for dissipating heat and without increasing energy consumption.

### SUMMARY

A robot according to application example of the present disclosure includes a base section; a robot arm connected to the base section along a first axis and configured to pivot about the first axis; a heat generating member; a first opening section arranged at a tip end side of the robot arm; a second opening section arranged further toward a first axis side than is the first opening section of the robot arm or arranged in the base section; and a flow path communicating between the first opening section and the second opening section and through which outside air flows from the second opening section toward the first opening section by operation of the robot arm, wherein the heat generating member is arranged at a position along the flow path.

### BRIEF DESCRIPTION OF THE DRAWINGS

FIG. 1 is a side view showing a robot system including a robot according to a first embodiment.

FIG. 2 is a schematic diagram of a flow path shown in FIG. 1.

FIG. 3 is a schematic diagram showing a drive section included in a robot according to a modification of the first embodiment.

FIG. 4 is a schematic diagram showing a robot according to a second embodiment.

FIG. 5 is a schematic diagram showing a robot according to a first modification of the second embodiment.

FIG. 6 is another modification of a second arm shown in FIG. 5, and is a simplified view of a first opening section, a second opening section, and a flow path when the second arm according to the modification is viewed from an upper side, a side, and a lower side.

FIG. 7 is still another modification of the second arm shown in FIG. 5, and is a simplified view of the first opening section, the second opening section, and the flow path when the second arm according to the modification is viewed from an upper side, a side, and a lower side.

FIG. 8 is a schematic diagram showing a robot according to a second modification of the second embodiment.

FIG. 9 is a schematic diagram showing a robot according to a third embodiment.

FIG. 10 is a schematic diagram showing a robot according to a fourth embodiment.

FIG. 11 is a schematic diagram showing a robot according to a fifth embodiment.

### DESCRIPTION OF EMBODIMENTS

Hereinafter, suitable embodiments of a robot of the present disclosure will be described in detail with reference to the accompanying drawings.

### 1. First Embodiment

First, a robot system including a robot according to a first embodiment will be described.

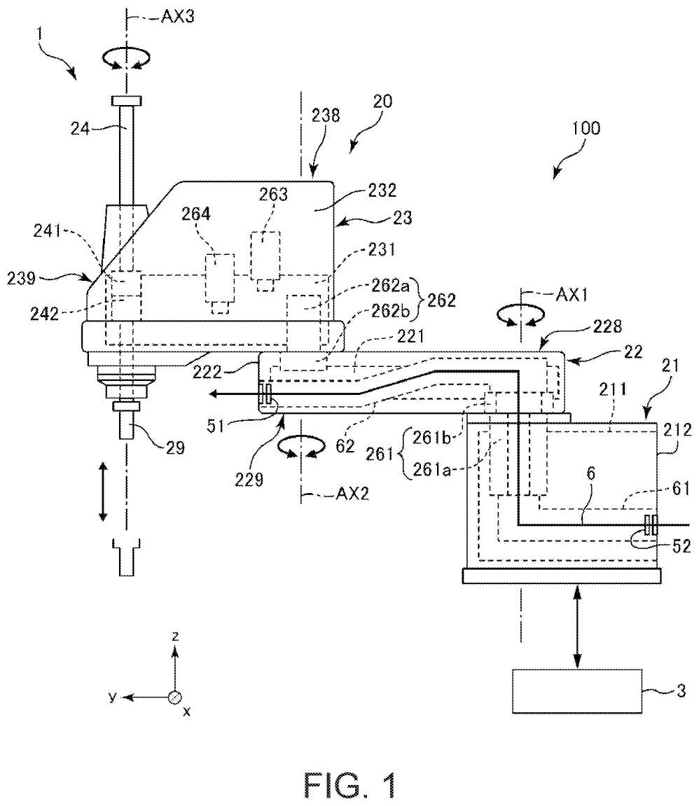

FIG. 1 is a side view showing a robot system 100 including a robot 1 according to the first embodiment. In the drawings of the present disclosure, for convenience of explanation, an x-axis, a y-axis, and a z-axis are set as three axes orthogonal to each other, and each of them is indicated by an arrow. In the following description, a direction parallel to the x-axis is referred to as an “x-axis direction”, a direction parallel to the y-axis is referred to as a “y-axis direction”, and a direction parallel to the z-axis is referred to as a “z-axis direction”. In addition, in the following description, a tip side of each illustrated arrow is referred to as “+(plus)”, and a base end side thereof is referred to as “−(minus)”. Further, in the following description, as an example, the z-axis is parallel to the vertical axis, a +z-axis direction is referred to as “above”, and a −z-axis direction is referred to as “lower”.

A robot system 100 shown in FIG. 1 includes a robot 1 and a control device 3 that controls operation of the robot 1. Applications of the robot system 100 are not particularly limited, and examples thereof include works such as holding, transporting, assembling, and inspecting a workpiece.

In the present embodiment, the robot 1 is a horizontal articulated robot (SCARA robot). The robot 1 includes a base section 21 and a robot arm 20. In the present embodiment, the robot arm 20 includes a first arm 22, a second arm 23, a shaft 24, and an end effector attachment section 29, which will be described later.

As described later, the robot 1 includes heat generating members such as a motor, a decelerator, a control substrate, and a power supply section. These heat generating members generate heat that accompanies, for example, energization or friction, or the like.

The robot 1 includes a first opening section 51, a second opening section 52, and a flow path 6, which will be described later, as units for quickly discharging heat generated from the heat generating members to outside. The first opening section 51 is provided on an outer cover of the first arm 22, and the second opening section 52 is provided on an outer cover of the base section 21. The flow path 6 connects the first opening section 51 and the second opening section 52.

In the robot 1, a speed difference occurs between the first opening section 51 and the second opening section 52 when the robot arm 20 operates. When a speed difference occurs, outside air flows into the flow path 6. By this, heat exchange can be performed between the heat generating member and outside air (air), and the heat generating member can be cooled.

Each section of the robot 1 will be described below.

### 1. 1. Base Section

The base section 21 is fixed to an installation surface (not shown) with bolts or the like. Examples of the installation surface include a floor surface, a wall surface, a ceiling surface, and an upper surface of a table, a platform, or the like. The outer shape of the base section 21 shown in FIG. 1 has a substantially rectangular parallelepiped shape. The outer shape of the base section 21 is not limited to the shape shown in FIG. 1, and may be any shape.

The base section 21 includes a base 211 and a cover 212. The base 211 is a member forming a framework of the base section 21. The cover 212 is an outer cover provided so as to cover the base 211.

The robot 1 includes a drive section 261. The drive section 261 generates driving force to pivot the first arm 22 about a first axis AX1 with respect to the base section 21. The drive section 261 includes a first motor 261a provided on the base section 21 and a first decelerator 261b provided on the first arm 22. Rotation output of the first motor 261a is decelerated by the first decelerator 261b and pivots the first arm 22 with respect to the base section 21.

Although the first axis AX1 is parallel to the z-axis in the present embodiment, the first axis AX1 may be non-parallel to the z-axis. The arrangement of the first motor 261a and the first decelerator 261b is not limited to the arrangement shown and, for example, the first decelerator 261b may be provided in the base section 21, or both of the first motor 261a and the first decelerator 261b may be provided in the first arm 22.

The drive section 261 includes an encoder (not shown) that detects the rotation amount thereof. A pivot angle of the first arm 22 with respect to the base section 21 can be detected by output from the encoder.

### 1. 2. Robot Arm

The robot arm 20 is connected to the base section 21. In the robot arm 20 shown in FIG. 1, the first arm 22, the second arm 23, the shaft 24, and the end effector attachment section 29 are connected in this order.

### 1. 2. 1. Arm and the Like

A base end section 228 of the first arm 22 is connected to the base section 21 along the first axis AX1. The first arm 22 is pivotable about the first axis AX1 with respect to the base section 21.

The first arm 22 includes a base 221 and a cover 222. The base 221 is a member forming a framework of the first arm 22. The cover 222 is an outer cover provided so as to cover the base 221.

A base end section 238 of the second arm 23 is connected to a tip end section 229 of the first arm 22 along a second axis AX2. The second arm 23 is pivotable about the second axis AX2 parallel to the first axis AX1 with respect to the first arm 22.

The second arm 23 includes a base 231 and a cover 232. The base 231 is a member forming a framework of the second arm 23. The cover 232 is an outer cover provided so as to cover the base 231.

The shaft 24 is connected to a tip end section 239 of the second arm 23. The shaft 24 is pivotable about a third axis AX3 parallel to the second axis AX2, and is capable of translation along the third axis AX3.

The shaft 24 is a cylindrical shaped shaft. A ball screw nut 241 and a spline nut 242 are installed at a position along the shaft 24 in a longitudinal direction, and the shaft 24 is supported by these. The shaft 24 can be regarded as a third arm connected to the tip end section 239 of the second arm 23.

In the present specification, an end remote from an axis about which each arm pivots is referred to as a “tip end”. For example, the tip end section 229 of the first arm 22 refers to an end section that is far from the first axis AX1 among both ends in a longitudinal direction of the first arm 22. Therefore, in FIG. 1, the left end of the first arm 22 or the vicinity thereof is the “tip end section 229”. In the present specification, the opposite end from a tip end is referred to as a “base end”. Therefore, for example, in FIG. 1, the right end of the first arm 22 or the vicinity thereof is the “base end section 228”.

### 1. 2. 2. Drive Section

The robot 1 includes drive sections 262, 263, and 264.

A drive section 262 is positioned at the base end section 238 of the second arm 23, and generates driving force for pivoting the second arm 23 about the second axis AX2 with respect to the first arm 22. The drive section 262 includes a second motor 262a provided on the base 231 of the second arm 23 and a second decelerator 262b provided on the base 221 of the first arm 22. Rotation output of the second motor 262a is decelerated by the second decelerator 262b to pivot the second arm 23 with respect to the first arm 22.

Although the second axis AX2 is parallel to the first axis AX1 in the present embodiment, the second axis AX2 may be non-parallel to the first axis AX1. The arrangement of the second motor 262a and the second decelerator 262b is not limited to the arrangement shown, and for example, the second decelerator 262b may be provided on the second arm 23, or both of the second motor 262a and the second decelerator 262b may be provided in the first arm 22.

The drive section 262 includes an encoder (not shown) that detects the rotation amount thereof. A pivot angle of the second arm 23 with respect to the first arm 22 can be detected by output from the encoder.

The drive section 263 is positioned between the base end section 238 and the tip end section 239 of the second arm 23, and generates driving force for rotating the ball screw nut 241 to cause translation of the shaft 24 in a direction along the third axis AX3. A drive section 263 includes a motor, a decelerator, a pulley, a belt, an encoder, and the like, which are not shown. The drive section 263 is provided on the base 231. The decelerator, the pulley, and the belt transmit rotation output of the motor to the ball screw nut 241. The encoder detects translation amount of the shaft 24 with respect to the second arm 23.

The drive section 264 is positioned between the base end section 238 and the tip end section 239 of the second arm 23, and generates driving force for rotating the shaft 24 about the third axis AX3 by rotating the spline nut 242. A drive section 264 includes a motor, a decelerator, a pulley, a belt, an encoder, and the like, which are not shown. The drive section 264 is provided on the base 231. The decelerator, the pulley and the belt transmit rotation output of the motor to the spline nut 242. The encoder detects rotation amount of the shaft 24 with respect to the second arm 23.

The end effector attachment section 29 for attaching an end effector is provided at a tip end section of the shaft 24. The end effector attached on the end effector attachment section 29 is not particularly limited, and examples thereof include a hand for holding an object, a tool for processing an object, an inspection device for inspecting an object, and the like. The robot arm 20 may be configured to include an end effector.

The driving force generated by the drive sections 261 to 264 is controlled by the control device 3 (to be described later). By this, posture of the robot arm 20 can be arbitrarily controlled, and an end effector can perform a desired work.

The drive sections 261 to 264 generate heat due to energization of the motors and friction in the decelerators. Therefore, the drive sections 261 to 264 are heat generating members. The base section 21 and the robot arm 20 may be provided with heat generating members other than the drive sections 261 to 264, for example, a control substrate, a power supply device, a communication device, a pump, and the like.

### 1. 3. Control Device

Operations of the robot 1 is controlled by the control device 3. The control device 3 may be arranged outside the base section 21 as shown in FIG. 1, or may be contained in the base section 21. The control device 3 controls driving of the drive sections 261, 262, 263 and 264 according to operation program stored in advance. By this, the control device 3 controls the operation of the robot arm 20.

### 1. 4. First Opening Section and Second Opening Section

The first opening section 51 shown in FIG. 1 is a hole opened in the cover 222 of the first arm 22. Specifically, the first opening section 51 is arranged at the tip end section 229 of the first arm 22. The first opening section 51 is an exhaust port through which air in the flow path 6 is discharged to outside. The second opening section 52 shown in FIG. 1 is a hole opened in the cover 212 of the base section 21. The second opening section 52 is an intake port that takes in outside air into the flow path 6. The arrangement of the first opening section 51 is not limited to the tip end section 229 of the first arm 22, but may be at a tip end side of the first arm 22, that is, in a range closer to a tip end than is the middle in a longitudinal direction of the first arm 22.

By arranging the first opening section 51 and the second opening section 52 at the above-described positions, when the robot arm 20 pivots (operates), a speed difference is generated between the first opening section 51 and the second opening section 52. For example, when the robot arm 20 pivots about the first axis AX1, movement speed of the first opening section 51 is higher than movement speed of the second opening section 52. For example, when the robot arm 20 pivots about the first axis AX1 without changing posture, movement speed of the first opening section 51 is obtained by the product of the pivot radius of the first opening section 51 and the angular velocity about the first axis AX1. On the other hand, since the second opening section 52 is provided in the base section 21, the movement speed thereof is zero. Such a difference in the movement speed generates pressure difference (difference in air pressure) between the first opening section 51 and the second opening section 52. As a result, air flow from the second opening section 52 toward the first opening section 51 is formed in the flow path 6. Air in the flow path 6 can be replaced by this air flow. By this, heat of the heat generating member received by air in the flow path 6 through heat exchange can be discharged to outside, and the heat generating member can be cooled.

Such air flow is naturally generated in accordance with pivot of the robot arm 20. Therefore, it is not necessary to use a heat dissipating member such as a heat sink or to lay a long thermal conduction path, and it is possible to reduce restrictions on the installation location of the flow path 6. Further, it is possible to form air flow without performing forced intake and forced exhaust using a fan or the like. By this, the heat generating member can be cooled without increasing energy consumption of the robot 1 due to heat dissipation.

The second opening section 52 may be arranged in the base end section 228 (a first axis AX1 side) of the first arm 22 instead of the base section 21. That is, the first opening section 51 may be arranged further toward a tip end side of the robot arm 20 than is the second opening section 52, and the second opening section 52 may be arranged further toward a first axis AX1 side than is the first opening section 51 of the robot arm 20. In this case, it is sufficient as long as the distance between the second opening section 52 and the first axis AX1 is smaller than the distance between the first opening section 51 and the first axis AX1. Even in this case, similarly to the above, when the robot arm 20 pivots about the first axis AX1, movement speed of the first opening section 51 is higher than movement speed of the second opening section 52, so that pressure difference due to a speed difference can be generated.

The shapes of the first opening section 51 and the second opening section 52 are not particularly limited. The first opening section 51 and the second opening section 52 shown in FIG. 1 are formed of a rectangular (slit-shaped) hole having a long axis in the z-axis direction as an example, but the hole may have any shape. Each of the first opening section 51 and the second opening section 52 may be formed of a plurality of holes.

When the entire robot arm 20 is viewed, the first opening section 51 is arranged further toward the tip end side of the robot arm 20, and the second opening section 52 is arranged further toward the first axis AX1 side than is the first opening section 51 of the robot arm 20 or is arranged in the base section 21. The first opening 51 is arranged at a tip end side of the robot arm 20 means that, when the robot arm 20 is in a posture in which the robot arm 20 has reached the farthest position it can, that is, when the robot arm 20 is set in a posture in which the distance between the end effector attachment section 29 and the first axis AX1 in a x-y plane is maximized, then the position of the first opening section 51 is farther from the first axis AX1 than is the second opening section 52.

With such an arrangement, when the robot arm 20 pivots at least about the first axis AX1, speed of the first opening section 51 in a circumferential direction is higher than speed of the second opening section 52 in a circumferential direction. Depending on a posture of the robot arm 20, the first opening section 51 may be closer to the first axis AX1 side than is the second opening section 52. However, it is considered that amount of time in which the robot arm 20 takes such a posture is a small part of the entire operation time of the robot arm 20. Therefore, the cooling effect based on a speed difference can be obtained by adopting the arrangement as described above.

### 1. 5. Flow Path

The flow path 6 is a pipe line that brings the first opening section 51 and the second opening section 52 into communication with each other. In each drawing of the present application, for convenience of illustration, a reference numeral indicating the flow path 6 is given to the air flow. The flow path 6 may not be airtight, but is desirably airtight along its entire length. By this, more outside air can be taken into the second opening section 52. As a result, a larger amount of heat can be absorbed in the flow path 6 and discharged to outside, so that cooling efficiency of the heat generating member can be enhanced.

The entire flow path 6 may be constituted by a single duct or a plurality of ducts. At least a part of an inner wall of the flow path 6 may be constituted by, for example, an outer surface of the base 221, an inner surface of the cover 222, or an outer surface of the heat generating member shown in FIG. 1. In particular, when an outer surface of the heat generating member constitutes an inner wall of the flow path 6, efficiency of heat exchange between air in the flow path 6 and the heat generating member can be easily increased. Therefore, in particular, cooling efficiency can be improved. When the entire inner wall of the flow path 6 can be constituted by an outer surface of the base 221, an inner surface of the cover 222, an outer surface of the heat generating member, or the like, a duct may not be used.

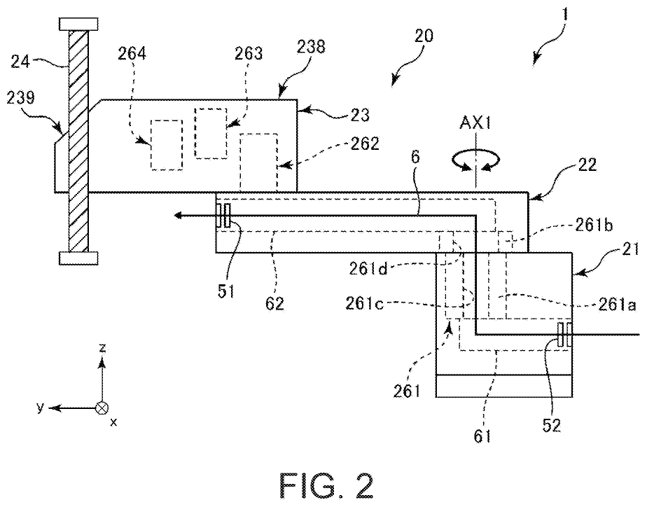

FIG. 2 is a schematic diagram of the flow path 6 shown in FIG. 1.

The first motor 261a shown in FIG. 2 includes a hollow section 261c. The hollow section 261c is a columnar space extending along the first axis AX1. The hollow section 261c constitutes a part of the flow path 6. Since the flow path 6 includes the hollow section 261c, heat exchange between the first motor 261a, which is a heat generating member, and air can be performed more efficiently.

The first motor 261a including the hollow section 261c may be, for example, a servomotor using a hollow shaft as a rotary shaft.

The first decelerator 261b shown in FIG. 2 has a hollow section 261d. The hollow section 261d is a columnar space extending along the first axis AX1. The hollow section 261d constitutes a part of the flow path 6. Since the flow path 6 includes the hollow section 261d, heat exchange between the first decelerator 261b, which is a heat generating member, and air can be performed more efficiently.

The first decelerator 261b including the hollow section 261d may be, for example, a gear device using a hollow shaft as a rotary shaft.

The flow path 6 shown in FIG. 2 includes a duct 61 connecting the second opening section 52 and the hollow section 261c, and a duct 62 connecting the hollow section 261d and the first opening section 51.

Examples of a constituent material of the ducts 61 and 62 include a resin material and a metal material. Among these, a metal material is desirably used as a constituent material in the vicinity of the heat generating member. Since a metal material is generally excellent in thermal conductivity, heat exchange can be performed particularly efficiently. For example, the duct 62 shown in FIG. 2 is arranged so as to pass through the vicinity of the drive section 262. In this case, by using a metal material as the constituent material of the duct 62 in the vicinity of the drive section 262, efficiency of heat exchange via the duct 62 can be increased. On the other hand, in order to reduce the weight of the duct 62 and to avoid an increase in temperature of outside air taken in, a resin material having a low specific gravity and a lower thermal conductivity than metal is desirably used for the other portions.

### 2. Modification

Next, a robot according to a modification of the first embodiment will be described.

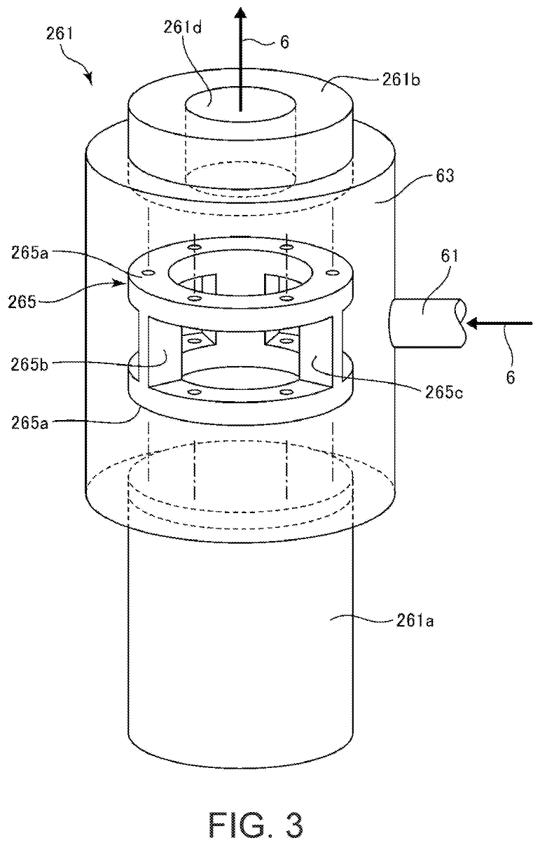

FIG. 3 is a schematic diagram showing the drive section 261 included in the robot 1 according to a modification of the first embodiment. In FIG. 3, a part of the drive section 261 is shown in an exploded state.

Hereinafter, the modification of the first embodiment will be described, but in the following description, differences from the first embodiment will be mainly described, and description of the same matters will be omitted. In FIG. 3, similar configurations as those of the first embodiment are denoted by the same reference numerals.

The present modification is the same as the first embodiment except that the configuration of the flow path 6 in the base section 21 is different.

In the first embodiment described above, the first motor 261a includes the hollow section 261c. On the other hand, in the present modification, as shown in FIG. 3, the first motor 261a does not include the hollow section 261c. On the other hand, in the present modification, the drive section 261 includes a connection section 265 provided between the first motor 261a and the first decelerator 261b. The connection section 265 includes two flange sections 265a and 265a having an annular shape, and column sections 265b for connecting these flange sections. The connection section 265 connects an output shaft of the first motor 261a and an input shaft of the first decelerator 261b to transmit rotation output.

In the connection section 265 shown in FIG. 3, for example, three column sections 265b are arranged at equal intervals along a circumferential direction of the flange sections 265a. By this, the connection section 265 is formed with window sections 265c for connecting inside and outside of the flange sections 265a. As a result, the connection section 265 connects the hollow section 261d of the first decelerator 261b to outside via the window sections 265c.

The connection section 265 is covered with a duct 63. The duct 63 is connected to the duct 61. By this, in the present modification, the flow path 6 through which air flows in the order of the duct 61, the duct 63, the window sections 265c, and the hollow section 261d is formed.

In such a modification, even in a case where the first motor 261a does not include the hollow section 261c, the flow path 6 from the base section 21 to the first arm 22 can be formed. By this, it is possible to realize the flow path 6 having high cooling efficiency while increasing degree of freedom in selecting the first motor 261a. As a result, the size and cost of the first motor 261a can be reduced.

A connection order of the first motor 261a, the first decelerator 261b, and the connection section 265 is not limited to the above-described order, and may be, for example, the connection section 265, the first decelerator 261b, and the first motor 261a.

In the above-described modification, the same effects as those of the first embodiment can be obtained.

### 3. Second Embodiment

Next, a robot according to a second embodiment will be described.

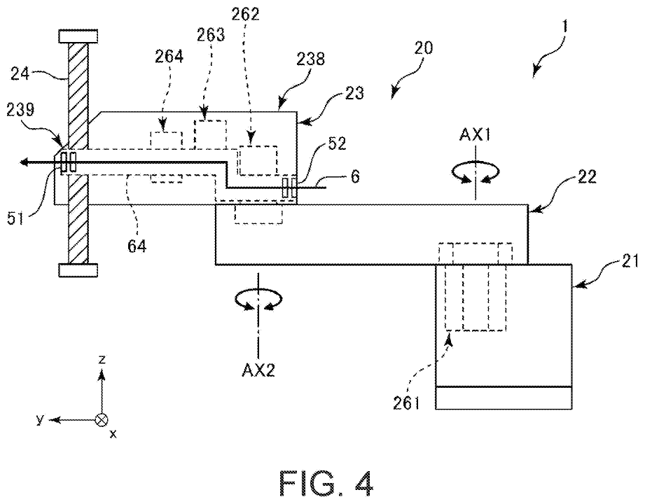

FIG. 4 is a schematic diagram showing the robot 1 according to the second embodiment.

Hereinafter, the second embodiment will be described, but in the following description, differences from the first embodiment will be mainly described, and description of the similar matters will be omitted. In FIG. 4, the same configurations as those of the first embodiment are denoted by the same reference numerals.

The second embodiment is the same as the first embodiment except for the arrangement of the first opening section 51 and the second opening section 52 and the arrangement of the flow path 6.

In the second embodiment, as shown in FIG. 4, the first opening section 51 is arranged on the tip end section 239 of the second arm 23. In FIG. 4, the second opening section 52 is arranged at the base end section 238 of the second arm 23. In this case, since it is not necessary to provide the flow path 6 up to the base section 21 and the first arm 22, there is an advantage that work for providing the flow path 6 can be facilitated while cooling the drive sections 262 to 264, and the structure of the flow path 6 can be simplified. The arrangement of the first opening section 51 is not limited to the tip end section 239 of the second arm 23, but may be a tip end side of the second arm 23, that is, a range closer to a tip end than is the middle in a longitudinal direction of the second arm 23.

Also in the second embodiment, when the robot arm 20 pivots about the first axis AX1, movement speed of the first opening section 51 is higher than movement speed of the second opening section 52. Depending on a posture of the robot arm 20, even though there may be moments when the speed relationship is not established, the probability that the speed relationship is established is high in most postures. In addition, when the second arm 23 pivots about the second axis AX2, movement speed of the first opening section 51 is higher than movement speed of the second opening section 52. Due to this speed difference, air flow from the second opening section 52 toward the first opening section 51 is formed in the flow path 6.

In the second embodiment, the flow path 6 includes a duct 64. The duct 64 is arranged so as to pass through the vicinity of the drive sections 262, 263, and 264, which are heat generating members. By this, the heat generating members can be cooled. As shown in FIG. 4, when the drive section 262 or the like has a long shape in the z-axis direction, the flow path 6 may also include a portion extending in the z-axis direction along the shape. By this, the drive section 262 and the like can be cooled more efficiently. A part of the duct 64 may be constituted of a metal material as described above or may be constituted of an outer surface of a heat generating member.

Also in the second embodiment as described above, when the entire robot arm 20 is viewed, it can be said that the first opening section 51 shown in FIG. 4 is arranged at a tip end side of the robot arm 20 and that the second opening section 52 is arranged further toward the first axis AX1 side than is the first opening section 51 of the robot arm 20.

With such an arrangement, when the robot arm 20 is pivoted at least about the first axis AX1, there is a high probability that speed of the first opening section 51 in a circumferential direction is higher than speed of the second opening section 52 in a circumferential direction. In addition, in the present embodiment, when the second arm 23 pivots about the second axis AX2, speed of the first opening section 51 in a circumferential direction is higher than speed of the second opening section 52 in a circumferential direction.

Also in the second embodiment as described above, the same effects as those of the first embodiment can be obtained.

### 4. Modification

Next, a robot according to modifications of the second embodiment will be described.

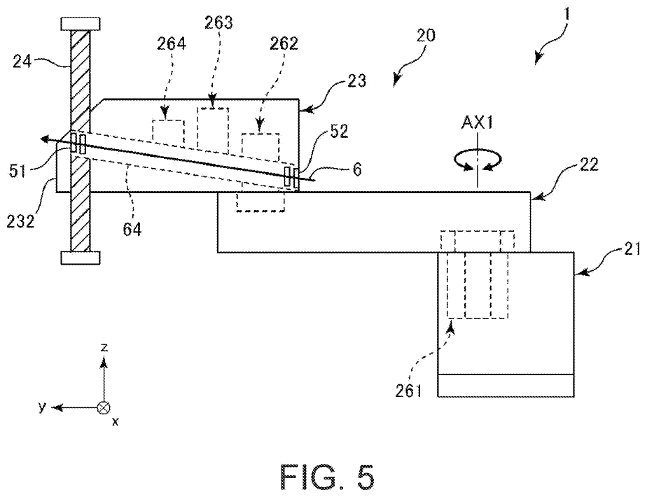

FIG. 5 is a schematic diagram showing a robot 1 according to a first modification of the second embodiment.

Hereinafter, the first modification of the second embodiment will be described, but in the following description, differences from the second embodiment will be mainly described, and description of the same matters will be omitted. In FIG. 5, the same configurations as those of the first embodiment and second embodiment are denoted by the same reference numerals.

The first modification is the same as the second embodiment except for the shape of the flow path 6.

The first opening section 51 shown in FIG. 5 is positioned vertically above the second opening section 52. The flow path 6 includes a duct 64 extending linearly so as to connect the first opening section 51 and the second opening section 52. According to the flow path 6 having such a shape, it is possible to generate not only air flow due to pressure difference described above but also air flow due to the stack effect. By this, cooling efficiency of the heat generating member can be enhanced. The stack effect means that air in the flow path 6 absorbs heat to have a low density and receives buoyancy.

When the stack effect is taken into consideration, it is desirable to optimize not only an extending direction of the flow path 6 but also the arrangement of the first opening section 51.

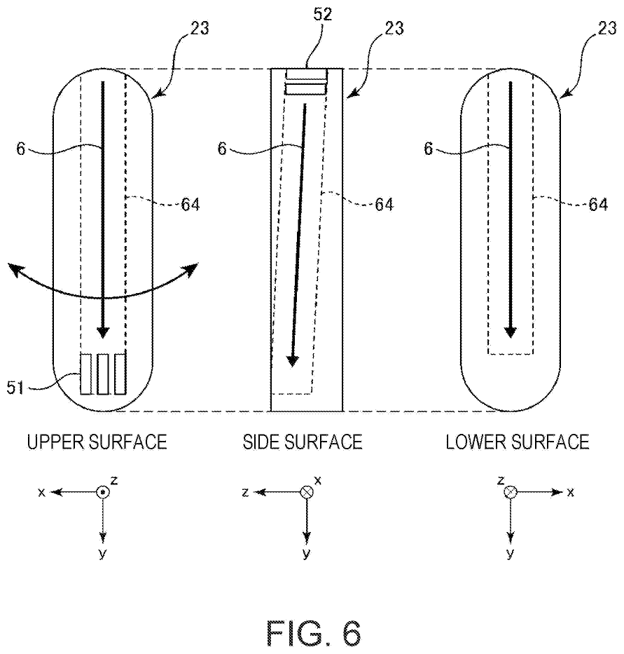

FIG. 6 is another modification of the second arm 23 shown in FIG. 5, and is a simplified view of the first opening section 51, the second opening section 52, and the flow path 6 when the second arm 23 according to the modification is viewed from an upper side, a side, and a lower side. The term “upper side” refers to a viewpoint from a position in the +z-axis direction in FIG. 5, the term “side” refers to a viewpoint from a position in the +x-axis direction in FIG. 5, and the term “lower side” refers to a viewpoint from a position in the −z-axis direction in FIG. 5.

The first opening section 51 shown in FIG. 5 is constituted by a hole penetrating the cover 232 along the y-axis or a hole penetrating the cover 232 along an axis obtained by tilting the y-axis toward the x-axis. On the other hand, the first opening section 51 shown in FIG. 6 is constituted by a hole penetrating the cover 232 along the z-axis, as shown in a top view. That is, the first opening section 51 shown in FIG. 6 is opened upward. Therefore, air rising in the flow path 6 due to the stack effect is more smoothly discharged from the first opening section 51. Therefore, cooling efficiency of the heat generating member can be particularly enhanced.

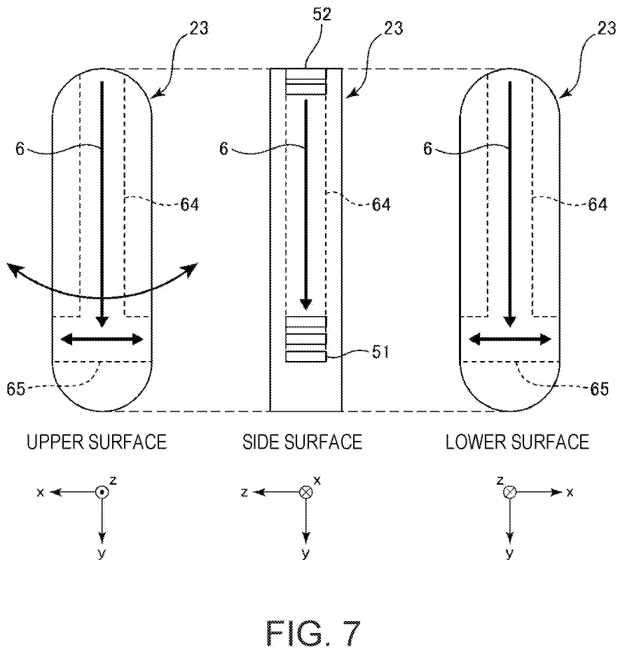

FIG. 7 is still another modification of the second arm 23 shown in FIG. 5, and is a simplified view of the first opening section 51, the second opening section 52, and the flow path 6 when the second arm 23 according to the modification is viewed from above, the side, and below.

The flow path 6 shown in FIG. 7 includes a duct 64 extending along the y-axis as shown in a top view and a side view, and a duct 65 that is connected to the tip end of the duct 64 and that extends along the x-axis as shown in the top view. That is, the flow path 6 shown in FIG. 7 includes the duct 64 similar to that shown in FIG. 5 and the duct 65 branched at the tip end of the duct 64. First opening sections 51 are arranged at both ends of the duct 65. In other words, the first opening sections 51 are arranged separately at two locations.

When the second arm 23 shown in FIG. 7 is pivoted, for example, about the second axis AX2, air flows in the duct 65 from one first opening section 51 toward the other first opening section 51. By this, pressure at a tip end of the duct 64 is reduced, and discharge of air in the duct 64 is promoted. Since the second arm 23 pivots about the second axis AX2 in a x-y plane, air flows in the duct 65 regardless of conditions under which the second arm 23 pivots. Therefore, the flow path 6 shown in FIG. 7 is useful in consideration of a pivot of the second arm 23.

Although not shown, the second opening section 52 may be provided with an obliquely inclined fin. Such a fin generates a swirling flow. By forming such a flow, air flow can be regulated. As a result, intake efficiency can be enhanced, and cooling efficiency of the heat generating member can be enhanced.

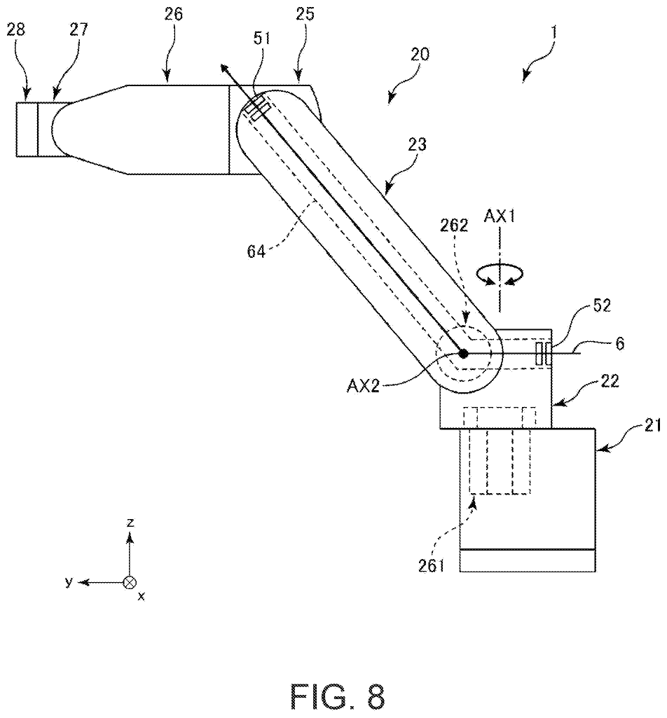

FIG. 8 is a schematic diagram showing the robot 1 according to a second modification of the second embodiment.

Hereinafter, the second modification of the second embodiment will be described, but in the following description, differences from the second embodiment will be mainly described, and description of the same matters will be omitted. In FIG. 8, the same configurations as those of the first embodiment and second embodiment are denoted by the same reference numerals.

The present second modification is the same as the second embodiment except that the shape of the robot arm 20 and the shape of the flow path 6 are different.

The robot 1 shown in FIG. 8 is a vertically articulated robot. The robot arm 20 shown in FIG. 8 includes a first arm 22, a second arm 23, a third arm 25, a fourth arm 26, a fifth arm 27, and a sixth arm 28. Therefore, the robot 1 shown in FIG. 8 is a six axes robot. The number of axes of the robot 1 is not limited to six, but may be five or less, or seven or more.

In the present second modification, as shown in FIG. 8, the first opening section 51 is arranged at a tip end side of the second arm 23. On the other hand, the second opening section 52 is arranged on the first arm 22. Also in the second modification, when the robot arm 20 pivots about the first axis AX1, air flow from the second opening section 52 toward the first opening section 51 is formed in the flow path 6.

Also in the present second modification, the flow path 6 includes the duct 64. The duct 64 is arranged so as to pass through the vicinity of the drive section 262 which is the heat generating member. By this, the heat generating member can be cooled.

In the modification as described above, the same effect as those of the first embodiment and second embodiment can be obtained.

### 5. Third Embodiment

Next, a robot according to a third embodiment will be described.

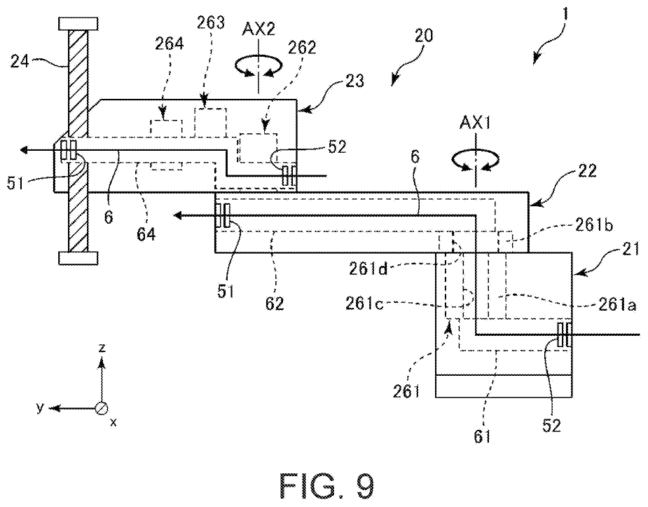

FIG. 9 is a schematic diagram showing a robot 1 according to the third embodiment.

Hereinafter, the third embodiment will be described, but in the following description, the difference from the first embodiment will be mainly described, and the description of the same matters will be omitted. In FIG. 9, the same configurations as those of the first embodiment are denoted by the same reference numerals.

The third embodiment is the same as the first embodiment and the second embodiment except that the third embodiment is a combination of the first embodiment and the second embodiment.

As shown in FIG. 9, similarly to the first embodiment, the third embodiment includes the first opening section 51 arranged on the first arm 22, the second opening section 52 arranged on the base section 21, and the flow path 6 arranged from the base section 21 to the first arm 22. As shown in FIG. 9, the third embodiment includes the first opening section 51, the second opening section 52, and the flow path 6 which are arranged in the second arm 23, similarly to the second embodiment.

Also in the third embodiment as described above, the same effects as those of the first embodiment and the second embodiment can be obtained. In particular, according to the third embodiment, since all of the drive sections 261 to 264 can be cooled by two flow paths 6, performance deterioration of the drive sections 261 to 264 due to heat generation can be particularly suppressed.

### 6. Fourth Embodiment

Next, a robot according to a fourth embodiment will be described.

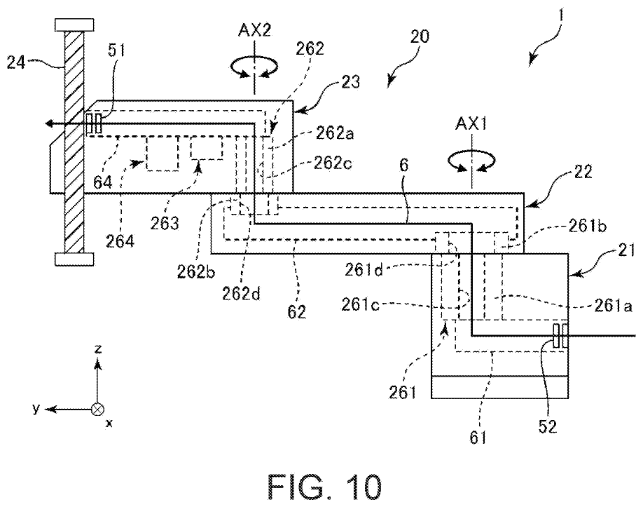

FIG. 10 is a schematic diagram showing a robot 1 according to the fourth embodiment.

Hereinafter, the fourth embodiment will be described, but in the following description, the difference from the first embodiment will be mainly described, and the description of the same matters will be omitted. In FIG. 10, the same configurations as those of the first embodiment are denoted by the same reference numerals.

The fourth embodiment is the same as the first embodiment except that the flow path 6 is arranged from the base section 21 to the second arm 23.

The second motor 262a shown in FIG. 10 includes a hollow section 262c. The hollow section 262c is a columnar space extending along the second axis AX2. The hollow section 262c constitutes a part of the flow path 6. Since the flow path 6 includes the hollow section 262c, heat exchange between the second motor 262a, which is a heat generating member, and air can be performed more efficiently.

The second decelerator 262b shown in FIG. 10 includes a hollow section 262d. The hollow section 262d is a columnar space extending along the second axis AX2. The hollow section 262d constitutes a part of the flow path 6. Since the flow path 6 includes the hollow section 262d, heat exchange between the second decelerator 262b, which is the heat generating member, and air can be performed more efficiently.

The first opening section 51 shown in FIG. 10 is arranged at a tip end side of the second arm 23, and the second opening section 52 is arranged at the base section 21.

Further, the flow path 6 shown in FIG. 10 includes the duct 61 connecting the second opening section 52 and the hollow section 261c of the first motor 261a, the duct 62 connecting the hollow section 261d of the first decelerator 261b and the hollow section 262d of the second decelerator 262b, and the duct 64 connecting the hollow section 262c of the second motor 262a and the first opening section 51. With such a flow path 6, all of the drive sections 261 to 264 can be cooled, and the drive sections 261 and 262 can be more efficiently cooled via the hollow sections 261c, 261d, 262c, and 262d. In addition, it is easy to maximize a speed difference between the first opening section 51 and the second opening section 52. Therefore, according to the robot 1 shown in FIG. 10, cooling efficiency of the heat generating member can be particularly enhanced.

The same effects as those of the first embodiment can also be obtained in the fourth embodiment described above.

### 7. Fifth Embodiment

Next, a robot according to a fifth embodiment will be described.

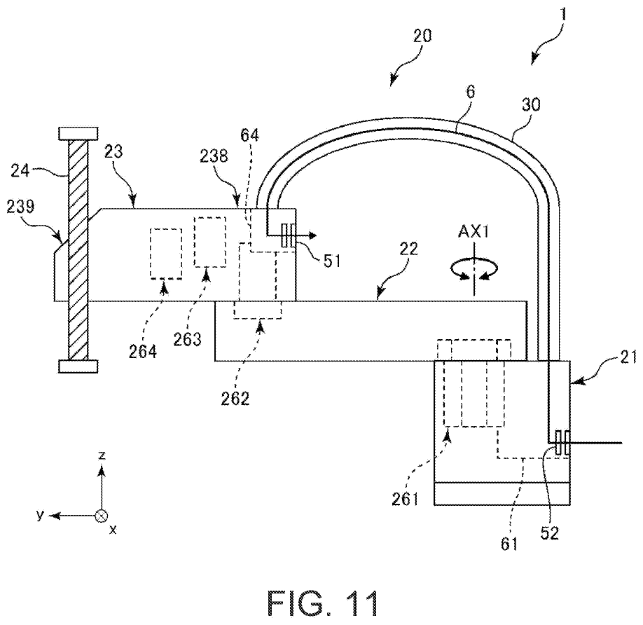

FIG. 11 is a schematic diagram showing a robot 1 according to the fifth embodiment.

Hereinafter, the fifth embodiment will be described, but in the following description, differences from the first embodiment will be mainly described, and description of the same matters will be omitted. In FIG. 11, the same configurations as those of the first embodiment are denoted by the same reference numerals.

The fifth embodiment is the same as the first embodiment except that the flow path 6 is arranged from the base section 21 to the second arm 23 via a pipe 30.

The robot 1 shown in FIG. 11 includes a pipe 30. The pipe 30 connects the base section 21 and the second arm 23. The inside of the pipe 30 is hollow, and a power line, a communication line, and the like are provided therein.

The first opening section 51 shown in FIG. 11 is arranged on the base end section 238 of the second arm 23, and the second opening section 52 is arranged on the base section 21. That is, the first opening section 51 is arranged relatively at a tip end side of the robot arm 20, and the second opening section 52 is arranged at the base section 21. Therefore, when the robot arm 20 is pivoted about the first axis AX1, a speed difference occurs between the first opening section 51 and the second opening section 52.

The flow path 6 shown in FIG. 11 includes the duct 61 provided in the base section 21, the inside of the pipe 30, and the duct 64 provided in the second arm 23. The duct 61 is provided in the vicinity of the drive section 261, and the duct 64 is provided in the vicinity of the drive section 262. According to such a flow path 6, it is possible to efficiently cool the drive sections 261 and 262 that generate a large amount of heat by effectively using an existing pipe 30 while shortening the extension of the ducts 61 and 64.

Also in the fifth embodiment as described above, the same effects as those of the first embodiment can be obtained.

### 8. Effects of Each Embodiment

As described above, the robot 1 includes the base section 21, the robot arm 20, the heat generating member, the first opening section 51, the second opening section 52, and the flow path 6. The robot arm 20 is connected to the base section 21 along the first axis AX1, and pivots about the first axis AX1. The first opening section 51 is arranged at a tip end side of the robot arm 20. The second opening section 52 is arranged further toward a first axis AX1 side than is the first opening section 51 of the robot arm 20 or is arranged in the base section 21. The flow path 6 is a pipe line in which the first opening section 51 and the second opening section 52 communicate with each other, and outside air flows from the second opening section 52 toward the first opening section 51 by operation of the robot arm 20. In the robot 1, a heat generating member is arranged at a position along the flow path 6.

According to such a configuration, it is possible to realize the robot 1 in which degree of freedom of the position where the flow path 6 is installed is high and the cooling (heat dissipation) of the heat generating member can be performed without increasing energy consumption associated with the heat dissipation.

The robot arm 20 may include the first arm 22 and the second arm 23. The first arm 22 pivots about the first axis AX1. The second arm 23 is connected to the tip end section 229 of the first arm 22 along the second axis AX2, and pivots about the second axis AX2.

According to such a configuration, for example, when the first opening section 51 is arranged on the second arm 23, air flow can be formed in the flow path 6 not only when the first arm 22 pivots about the first axis AX1 but also when the second arm 23 pivots about the second axis AX2.

The robot 1 may include the first motor 261a having the hollow section 261c (a first hollow section), as the heat generating member. The first motor 261a is provided on the base section 21 and drives the first arm 22. In this case, the second opening section 52 may be arranged on the base section 21, and the flow path 6 may include a hollow section 261c.

According to this configuration, heat exchange between the first motor 261a, which is a heat generating member, and air can be performed more efficiently.

The first opening section 51 may be arranged at a tip end side of the first arm 22. By this, heat absorbed from the heat generating members contained in the base section 21 and the first arm 22 can be efficiently discharged from the first opening section 51 as the robot arm 20 pivots.

The robot 1 may include the second motor 262a having the hollow section 262c (a second hollow section), as the heat generating member. The second motor 262a is provided on the second arm 23 and drives the second arm 23. In this case, the flow path 6 may include the hollow section 262c.

According to such a configuration, heat exchange between the second motor 262a, which is a heat generating member, and air can be performed more efficiently.

The first opening section 51 may be arranged at a tip end side of the second arm 23. By this, the speed difference between the first opening section 51 and the second opening section 52 can be increased. Further, heat absorbed from the heat generating members contained in the base section 21, the first arm 22, and the second arm 23 can be efficiently discharged from the first opening section 51 as the robot arm 20 pivots.

The first opening section 51 may be arranged at a tip end side of the second arm 23, and the second opening section 52 may be arranged at a first axis AX1 side of the second arm 23 or on the first arm 22. In this case, the robot 1 may include the second motor 262a as the heat generating member, that is provided on the second arm 23 and that drives the second arm 23. The second motor 262a is desirably arranged at a position along the flow path 6.

According to such a configuration, the speed difference between the first opening section 51 and the second opening section 52 can be increased. Since it is not necessary to provide the flow path 6 up to the base section 21, the work of providing the flow path 6 is facilitated, and the structure of the flow path 6 can be simplified.

The first opening section 51 may be arranged on the second arm 23, and the second opening section 52 may be arranged in the base section 21. In this case, the robot 1 may include the pipe 30. The pipe 30 connects the base section 21 and the second arm 23. Desirably, the flow path 6 includes an inside of the pipe 30.

According to such a configuration, the inside of the pipe 30 which is provided for a power line, a communication line or the like can be effectively used as a part of the flow path 6. By this, it is possible to efficiently cool the drive sections 261 and 262, which are provided on the base section 21 and the second arm 23 and generate a large amount of heat, while reducing the length of the duct included in the flow path 6.

The first opening section 51 may be positioned vertically above the second opening section 52. By this, in the flow path 6, not only air flow caused by a speed difference but also air flow caused by the stack effect can be generated. As a result, cooling efficiency of the heat generating member can be enhanced.

Although the robot of the present disclosure has been described based on the illustrated embodiment, the robot of the present disclosure is not limited to the embodiment. For example, a robot of the present disclosure is such that any part of the above embodiments may be replaced with an arbitrary configuration having the same function, arbitrary configuration may be added to the above embodiments, or a plurality of the above embodiments may be combined. The robot of the present disclosure can be applied to a multi-arm robot having a plurality of robot arms, for example, in addition to the above-described horizontal articulated robot and the vertical articulated robot.

What is claimed is:

1. A robot comprising:
a base section;
a robot arm connected to the base section along a first axis and configured to pivot about the first axis;
a heat generating member;
a first opening section arranged at a tip end side of the robot arm;
a second opening section arranged further toward a first axis side than is the first opening section of the robot arm or arranged in the base section; and
a flow path communicating between the first opening section and the second opening section and through which outside air flows from the second opening section toward the first opening section by operation of the robot arm, wherein
the heat generating member is arranged at a position along the flow path.

2. The robot according to claim 1, wherein
the robot arm includes
a first arm configured to pivot about the first axis and
a second arm connected to a tip end section of the first arm along a second axis and configured to pivot about the second axis.

3. The robot according to claim 2, wherein
the robot includes, as the heat generating member, a first motor that is provided on the base section, that drives the first arm, and that has a first hollow section,
the second opening section is arranged in the base section, and
the flow path includes the first hollow section.

4. The robot according to claim 3, wherein
the first opening section is arranged at a tip end side of the first arm.

5. The robot according to claim 3, wherein
the robot includes, as the heat generating member, a second motor that is provided on the second arm, that drives the second arm, and that has a second hollow section and
the flow path includes the second hollow section.

6. The robot according to claim 5, wherein
the first opening section is arranged at a tip end side of the second arm.

7. The robot according to claim 2, wherein
the robot includes, as the heat generating member, a second motor that is provided on the second arm and that drives the second arm,
the second motor is arranged at a position along the flow path,
the first opening section is arranged at a tip end side of the second arm, and
the second opening section is arranged at a first axis side of the second arm or in the first arm.

8. The robot according to claim 2, further comprising:
a pipe connecting the base section and the second arm, wherein
the flow path includes an inside of the pipe,
the first opening section is arranged in the second arm, and
the second opening section is arranged in the base section.

9. The robot according to claim 1, wherein
the first opening section is positioned vertically above the second opening section.
